(19) United States
(12) Patent Application Publication
(10) Pub. No.: US 2021/0304296 A1
(43) Pub. Date: Sep. 30, 2021

(54) WORK POD SYSTEM

(71) Applicant: Charles Isgar, Scottsdale, AZ (US)

(72) Inventor: Charles Isgar, Scottsdale, AZ (US)

(21) Appl. No.: 17/201,799

(22) Filed: Mar. 15, 2021

Related U.S. Application Data
(60) Provisional application No. 63/001,015, filed on Mar. 27, 2020.

(51) Int. Cl. G06Q 30/06; G06Q 10/02

(52) U.S. Cl. CPC G06Q 30/0645; G06Q 10/02

(57) ABSTRACT

Described is a work pod system that allows a host to rent out workspace located in the host's home to another user of the system. The system includes a server having a memory storing work pod information, a renter computing device coupled to the server; and a user computing device coupled to the server. The system operates to allow a user to access the system, see the workspaces available at work pods, and then book the workspace for certain days and times. The server may be programmed to interact with both the user device and the renter device for operation of the system.

### CROSS REFERENCE TO RELATED APPLICATION

This application claims priority to U.S. Provisional patent application to Charles Isgar entitled “WORK POD SYSTEM,” Ser. No. 63/001,015, filed Mar. 27, 2020, the disclosure of which is hereby incorporated entirely herein by reference.

### BACKGROUND OF THE INVENTION

### Technical Field

This invention generally relates to a system for sharing workspace, and more specifically to an organized system for sharing home workspaces with others.

### State of the Art

There are several instances where an individual may have the need for a workspace that is not typical. One category of individuals are gig economy workers who may not have traditional office space and would like to find working spots outside of their apartment or home. Some of these gig workers also may enjoy working around other people and do not have the ability to do so from within their homes. Other categories of individuals may be individuals who are travelling, individuals who have the inability to get to an office, or individuals who desire a close workspace that is separate from the individual's home to avoid commuting in traffic. Conventionally, in such instances, the individual would need to rent a certain workspace from a retail open workspace building, or the like, where office space is rented by the hour. There is not a system that allows an individual to obtain use of a workspace in a home from another or for a person to rent or lease a workspace in his home to another for use.

Accordingly, what is needed is an organized system for sharing a home workspace by a host allowing a user to rent the home workspace of the host for a set amount of time.

### SUMMARY OF THE INVENTION

An embodiment includes a work pod system comprising: a server having a memory storing work pod information; a renter computing device coupled to the server; and a user computing device coupled to the server, wherein the server is programmed to: receive and process a signal that the user computing device has accessed the system and is searching for a workspace to rent; send, for display, on the user computing device, work pod information, including available workspace to rent; send a work pod request for rental of a workspace owned by a renter associated with the renter computing device to the renter computing device, including a selected date and duration of renting; receive and process a signal from the renter computing device accepting the work pod request; and automatically reserve the requested workspace for the selected date and duration, in response to receiving the acceptance signal from the renter computing device.

The system may comprise more than one of the user computing device. The system may comprise more than one of the renter computing device. The user computing device may be a mobile computing device. A mobile application may operate on the user computing device. The renter computing device may be a mobile computing device. A mobile application may operate on the renter computing device. The work pod information may comprise a photo of the workspace. The work pod information may comprise location of the workspace. The work pod information may comprise if the renter is on premise. The work pod information may comprise if the renter has skills offered for contracting to a user.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 a diagrammatic view of a work pod system according to an embodiment;

FIG. 2A is a user interface for interaction with a work pod system according to an embodiment;

FIG. 2B is a user interface for interaction with a work pod system according to an embodiment;

FIG. 3A is a user interface for interaction with a work pod system according to an embodiment;

FIG. 3B is a user interface for interaction with a work pod system according to an embodiment;

FIG. 4A is a user interface for interaction with a work pod system according to an embodiment;

FIG. 4B is a user interface for interaction with a work pod system according to an embodiment;

FIG. 5A is a user interface for interaction with a work pod system according to an embodiment;

FIG. 5B is a user interface for interaction with a work pod system according to an embodiment;

FIG. 5C is a user interface for interaction with a work pod system according to an embodiment;

FIG. 5D is a user interface for interaction with a work pod system according to an embodiment; and

FIG. 5E is a user interface for interaction with a work pod system according to an embodiment.

### DETAILED DESCRIPTION OF EMBODIMENTS OF THE INVENTION

Embodiments of the present invention relate to a work pod system for renting a home workspace from others using the system. As used herein, the term “work pod” refers to one or more designated workspace areas within a host's home that is for rent. The system is a formalized system that allows individual hosts (renters) to share these designated home workspaces with others in need of workspace and effect payment, lending and use of home workspaces. It establishes an organized system with a set of rules of expectation of each party. Modern technology utilized by the system operates as a new and efficient work pod system. The system may include the use of a mobile application operating on a user computing device and a renter computing device that may be a mobile computing device like a smartphone, a tablet, a wearable, and the like; and/or the system may operate on any type of computing device as a downloadable application or even as a web application.

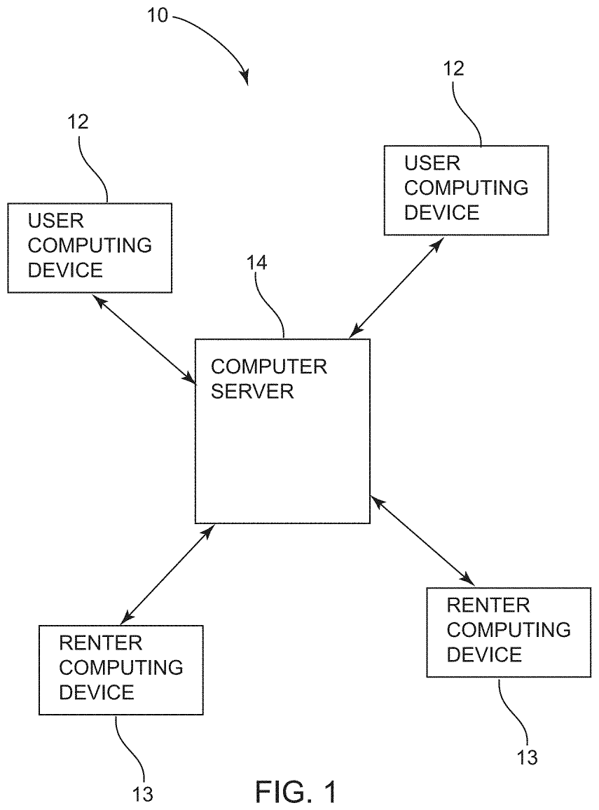

FIG. 1 depicts an embodiment of a work pod system 10. The system 10 may include user computing devices 12, renter computing devices 13 and a server 14, wherein each user computing device 12 and renter computing device 13 is coupled to the computer server 14. This coupling may be a network connection, such as a wireless connection through an Internet connection, a Wi-Fi connection, a Bluetooth connection or the like, wherein the user computing devices 12 and renter computing devices 13 may communicate with and receive communication from the server 14. The user computing device 12 and/or the renter computing devices 13 may be any of a desktop computer, a laptop, a tablet, a smartphone, wearable devices and the like. The server 14, in some embodiments, may be a computer server or a cloud-based infrastructure architecture.

The server 14 may include a memory storing work pod information. The work pod information may include information that a home workspace is available for rent, a photo of the workspace, location of the workspace, available dates and duration the workspace is available for rent, demographic information, and the like.

A user computing device 12 and a renter computing device 13 may each be coupled to the server 14, and the server 14 may be programmed to receive and process a signal that the user computing device has accessed the system and is searching for a workspace to rent; send, for display, on the user computing device, work pod information, including available workspace to rent; send a work pod request for rental of a workspace owned by a renter associated with the renter computing device to the renter computing device, including a selected date and duration of renting; receive and process a signal from the renter computing device accepting the work pod request; and automatically reserve the requested workspace for the selected date and duration, in response to receiving the acceptance signal from the renter computing device. In some instances, the host may plan to not be at the premises during work pod use and would be listed by the system as no host on premises for that work pod. In other instances, the host may have skills that she offers for contracting purposes to the renters of the workspace, and the system would provide a means for booking such use of skills.

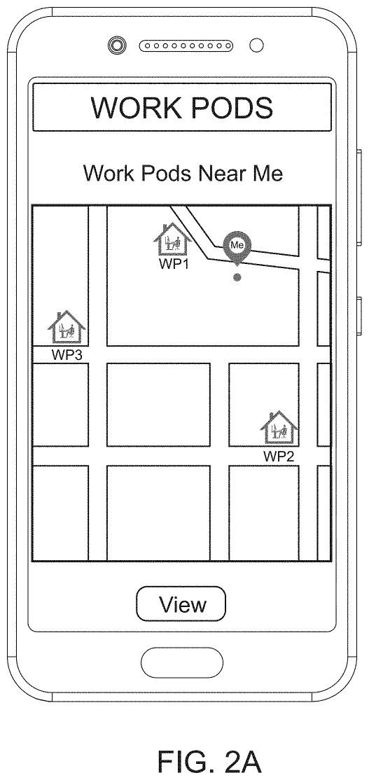

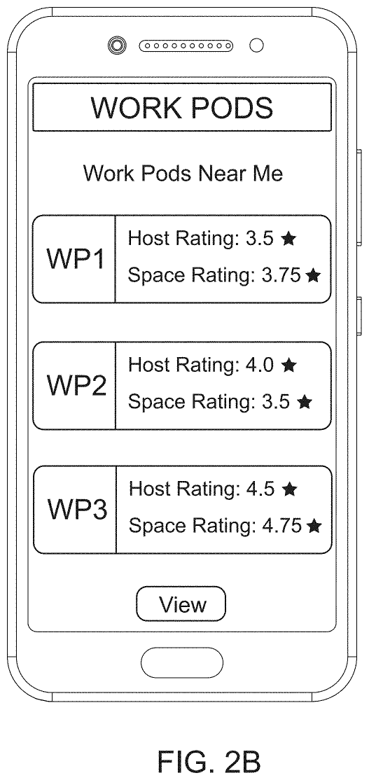

Referring to FIGS. 2A-5E, the system 10 may then allow a user to access the system through the user computing device 12. An app operating on a user computing device, such as, but not limited to, a mobile app operating on a smart phone may connect a user computing device with the server. The operation of the user computing device and the server may include a user interface and server operating together with the server being programmed to perform the function and send for display on the user computing device the interfaces depicted in FIGS. 2A-5E.

For example, FIG. 2A depicts a user computing device with an interface showing a map having the user's location or the location of the user computing device. Additionally, the map displays locations of work pods or workspaces available for rent indicated as WP1, WP2, and WP3. It will be understood that more or fewer work pods may be depicted. In some embodiments, or at the desire of the user, the user computing device may depict the available workspaces for rent in a list form as shown in FIG. 2B, wherein the same work pods WP1, WP2, and WP3 are depicted in list form. Further, FIG. 2B depicts ratings of the host for each work pod and a rating of the workspace(s) available for rent at each work pod.

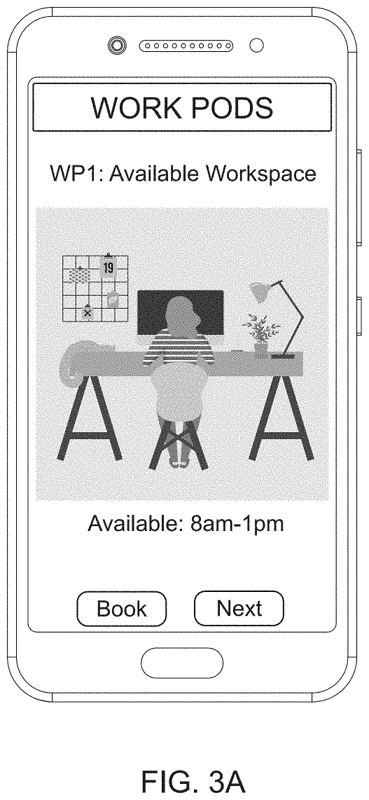

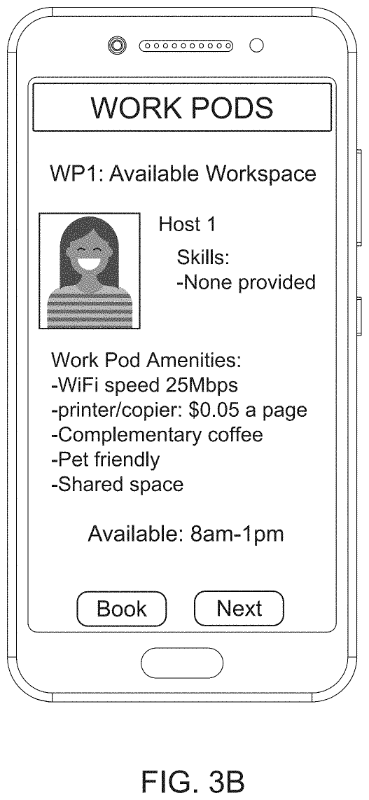

The system may include displaying an interface with details about each work pod, like WP1, WP2, and WP3 as examples. For example, FIG. 3A depicts a view of the workspace and time of availability of the workspace located at WP1. The user may select to see additional details, and the user interface depicted in FIG. 3B may be displayed to show an image of the host, any offered skills of the host, and work pod amenities. For example, the amenities of WP1 may include, WiFi speed of 25 Mbps, printer/copier at a predetermined rate for each print or copy, complementary coffee, pet friendly and whether it is a shared space.

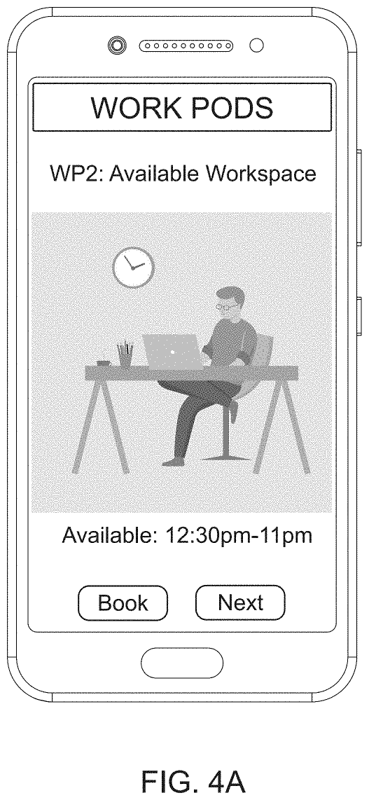

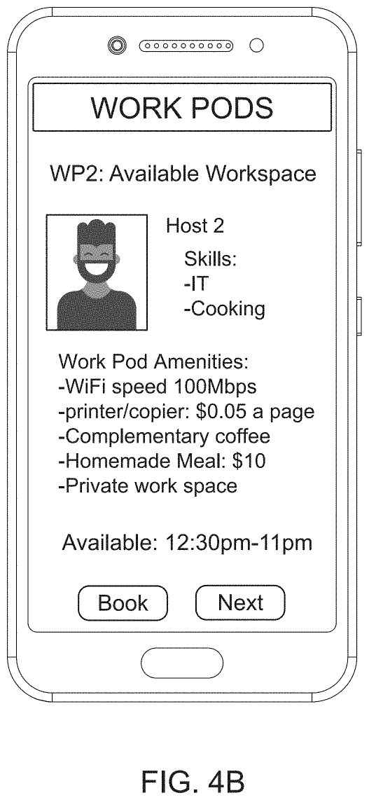

Another example is shown in FIGS. 4A and 4B. FIG. 4A depicts a view of the workspace and time of availability of the workspace located at WP2. The user may select to see additional details, and the user interface depicted in FIG. 4B may be displayed to show an image of the host, any offered skills of the host, and work pod amenities. For example, the amenities of WP2 may include, WiFi speed of 100 Mbps, printer/copier at a predetermined rate for each print or copy, complementary coffee, a homemade meal at a predetermined rate for each meal and whether it is a private space.

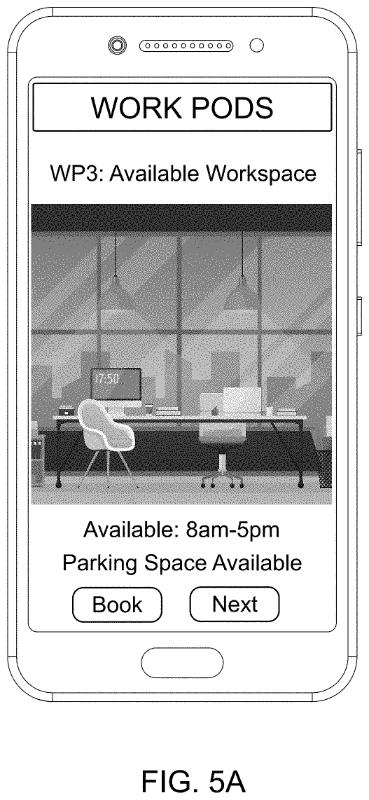

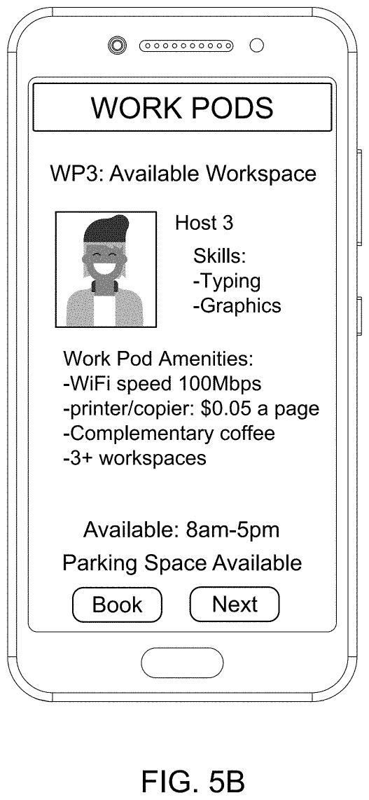

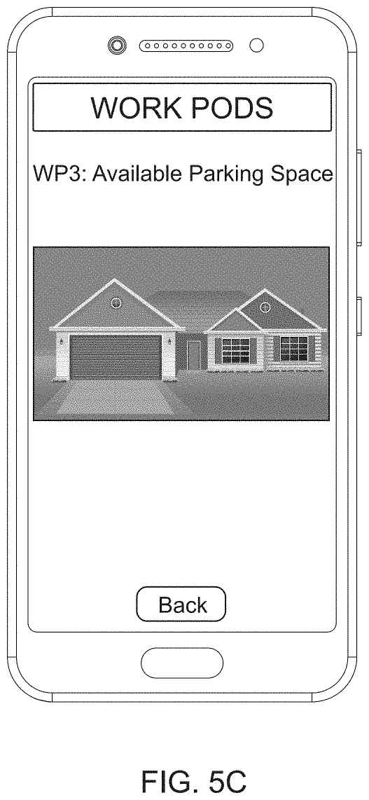

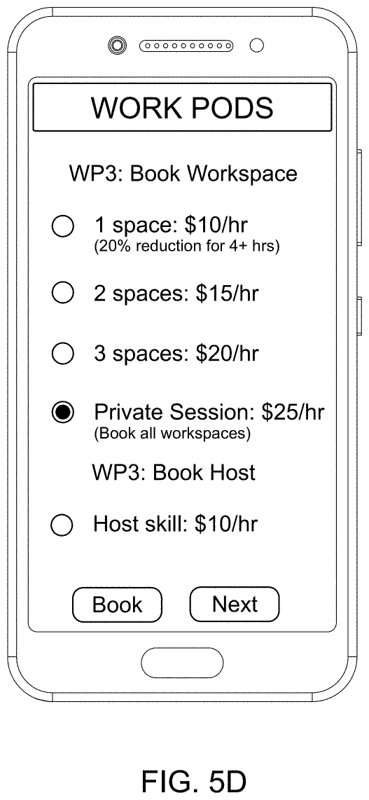

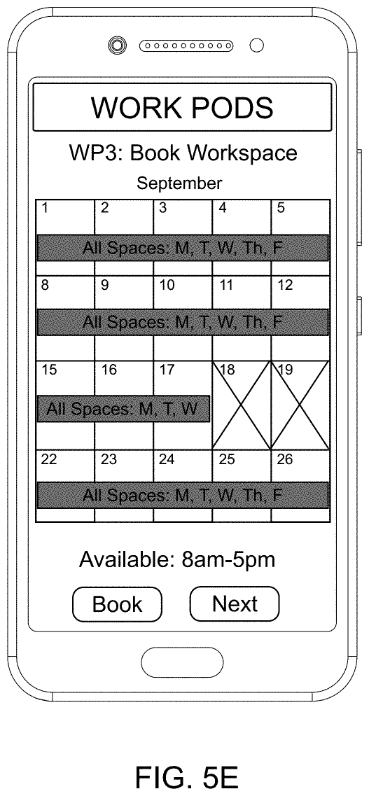

Yet another example is shown in FIGS. 5A-5E, wherein additional interfaces are depicted related to WP3 for booking the workspace(s). FIG. 5A depicts a view of the workspace and time of availability of the workspace located at WP3. The interface may also depict that there is parking space available. The user may select to see additional details, and the user interface depicted in FIG. 5B may be displayed to show an image of the host, any offered skills of the host, and work pod amenities. For example, the amenities of WP3 may include, WiFi speed of 100 Mbps, printer/copier at a predetermined rate for each print or copy, complementary coffee and multiple workspaces available for rent. The user may elect to see the parking space and may be directed to the interface shown in FIG. 5C to see how many parking spaces are available. Further, the user may then select to book the work pod, such as WP3, and be directed to a booking interface. The booking interface allows for the user to select the workspace he or she wished to book. As an example, and not as a limitation, a user seeking to book WP3, may select one space, two spaces, 3 spaces or an entire house. The rates for each option are depicted and the user may select a desired option. It allows the host to charge certain amounts for each space, offer discounts for renting for an extended period of time or reduced rates for booking more than one workspace. In the example shown in FIG. 5D, the user may select the entire home in order to have a space for his entire team to work. The booking interface shown in FIG. 5D may also include an option to book a host, wherein the user may select to book the host at a predetermined rate. When booking, the user computing device may depict the dates the user is seeking to book the work pod, as shown in FIG. 5E. It may be a calendar view showing the day or multiple days the work pod is being booked and how many spaces of the work pod are being booked. Further the calendar may depict any days that are unavailable for renting.

It will be appreciated that the system 10 may be utilized for several purposes or in several ways. For example, the system could be used for remote teams of a company; companies could rent houses close to its work force and create a spot for teams instead of expensive office real estate; it can operate for workers by the hour or all day with upcharges for equipment use; the system could be utilized by workers that are in an area between clients or meetings and need a spot to work; hosts could offer food or other incentives; renters could be pre-screened by the system for safety; the host could rent part of a house when they are not there during the day; some hosts could also offer babysitting service while a parent works from a rented workspace; many people have houses that are too large with an extra dining room or other space that can be converted to workspaces; the host could post photos and limits to the number of guests at any one time; some hosts may have special skills to offer for an additional fee such as typing, cooking, cold calling, legal, CPA, etc.; some hosts may offer a room to rent for sleeping or napping during breaks; some longer term hosts may offer an address for delivery of mail or packages.

Embodiments may be available on or through the internet, such as through domain names reserved and owned by Applicant that include work-pod.com, walktoworks.com, workmyhouse.com, home2-work.com, hm2wk.com, hmpods.com, casa-work.com, casa2work.com and the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A work pod system comprising:
a server having a memory storing work pod information;
a renter computing device coupled to the server; and
a user computing device coupled to the server, wherein the server is programmed to:
receive and process a signal that the user computing device has accessed the system and is searching for available workspace to rent;
send, for display, on the user computing device, work pod information, comprising the available workspace to rent;
send a work pod request for rental of the workspace owned by a renter associated with the renter computing device to the renter computing device, comprising a selected date and duration of renting;
receive and process a signal from the renter computing device accepting the work pod request; and
automatically reserve the requested workspace for the selected date and duration, in response to receiving the acceptance signal from the renter computing device.

2. The work pod system of claim 1, further comprising more than one of the user computing device.

3. The work pod system of claim 1, further comprising more than one of the renter computing device.

4. The work pod system of claim 1, wherein the user computing device is a mobile computing device.

5. The work pod system of claim 4, wherein a mobile application operates on the user computing device.

6. The work pod system of claim 1, wherein the renter computing device is a mobile computing device.

7. The work pod system of claim 6, wherein a mobile application operates on the renter computing device.

8. The work pod system of claim 1, wherein the work pod information further comprises a photo of the workspace.

9. The work pod system of claim 1, wherein the work pod information further comprises location of the workspace.

10. The work pod system of claim 1, wherein the work pod information further comprises if the renter is on premise.

11. The work pod system of claim 1, wherein the work pod information further comprises if the renter has skills offered for contracting to a user.
